(19) United States
(12) Patent Application Publication
(10) Pub. No.: US 2009/0269090 A1
(43) Pub. Date: Oct. 29, 2009

(54) IMAGE FORMING APPARATUS AND PRINTING METHOD THEREFOR

(75) Inventor: Reiji MURAKAMI, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/201,891

(22) Filed: Aug. 29, 2008

Related U.S. Application Data
(60) Provisional application No. 60/969,585, filed on Aug. 31, 2007.

(51) Int. Cl. G03G 15/00

(52) U.S. Cl. 399/45; 399/81

(57) ABSTRACT

An image forming apparatus according to an embodiment of the present invention includes an apparatus main body, an operation panel that is provided in the apparatus main body and used for instructing printing of a formed image, plural paper feeding cassettes that store paper for color printing or paper for monochrome printing on which the image is printed, and a cassette-paper-correspondence recognizing unit that is provided in the apparatus main body and recognizes whether the paper stored in the plural paper feeding cassettes is the paper for color printing or the paper for monochrome printing.

### CROSS-REFERENCE TO RELATED APPLICATION

The present invention claims the benefit of the priority of the provisional application No. 60/969,585 filed on Aug. 31, 2007, entire contents of which are incorporated herein by reference.

### TECHNICAL FIELD

The present invention relates to an image forming apparatus and a printing method therefor, and, more particularly to an image forming apparatus including a paper-type distinguishing device and a printing method therefor.

### BACKGROUND

In image forming apparatuses such as a multifunction color copying apparatus (a multifunction peripheral (MFP)), types of media on which color images and the like are printed are increasing. Even if printing media are limited to paper, various kinds of paper with different thicknesses and the like are used.

Such types of paper are usually distinguished by basis weight (unit; g/m²) indicating weight per a fixed area. For example, types of paper belonging to groups of basis weights 64 to 105, 106 to 163, 164 to 209, 210 to 256, and 257 to 300 are referred to as plain paper, thick paper 1, thick paper 2, thick paper 3, and thick paper 4, respectively. Usually, the basis weights are written on a package of paper. When a user selects one of the groups of basis weights written on the package, a printing condition corresponding to a type of the paper is automatically set.

However, the classification only by the basis weights may be insufficient in practice. For example, when it is desired to print images as color images, satisfactory color images can be obtained by printing the images on paper having high surface smoothness sold as recommended paper for color printing. However, normal paper for monochrome printing having the same basis weight is also sold.

Therefore, it is impossible to distinguish, only with basis weight, whether paper is suitable for printing of color images or paper suitable for monochrome printing. In general, paper recommended for color printing is several times as expensive as paper for black and white. Therefore, there is a high demand for using the paper recommended for color printing only in the color printing.

The present invention provides an image forming apparatus that automatically prints, when it is appropriate to print an image in color, the image on paper suitable for color printing.

There is known a paper-type distinguishing device that detects basis weight and paper thickness, calculates density of paper from values of the basis weight and the paper thickness, and distinguishes pieces of paper having different levels of surfaces smoothness from the obtained density and paper thickness (JP-A-2003-112840).

However, there is a problem in that accurate detection of basis weight is realistically difficult. An image forming apparatus that distinguishes, from calculated density of paper, whether the paper is paper suitable for color printing is not known.

### SUMMARY

The present invention has been devised in view of the problems in the past described above and it is an object of the present invention to provide an image forming apparatus that prints an image suitable for color printing on paper suitable for color printing and a printing method for the image forming apparatus.

According to an aspect of the present invention, there is provided an image forming apparatus including an apparatus main body, an operation panel that is provided in the apparatus main body and used for instructing printing of a formed image, plural paper feeding cassettes that store paper for color printing or paper for monochrome printing on which the image is printed, and a cassette-paper-correspondence recognizing unit that is provided in the apparatus main body and recognizes whether the paper stored in the plural paper feeding cassettes is the paper for color printing or the paper for monochrome printing.

According to the aspect of the present invention, an image suitable for color printing is printed on the paper for color printing.

### DESCRIPTION OF THE DRAWINGS

FIG. 1 is a schematic perspective view of a multifunction color copying apparatus (an MFP) according to an embodiment of the present invention;

FIG. 2 is a schematic diagram of an electric circuit configuration and paper feeding cassettes of the multifunction color copying apparatus;

FIG. 3 is a diagram showing a display screen displayed on a touch panel display of an operation panel 102 when basis weight is inputted;

FIG. 4 is a diagram showing a configuration example of a cassette-paper-correspondence recognizing unit 130 according to the embodiment;

FIG. 5 is a diagram for explaining a method of detecting paper thickness according to the embodiment;

FIG. 6 is a diagram showing a configuration example of a paper-feed control unit 150 according to the embodiment;

FIG. 7 is a flowchart for explaining operations in a correspondence relation storage mode according to the embodiment; and

FIG. 8 is a diagram for explaining operations in a printing mode according to the embodiment.

### DETAILED DESCRIPTION

An embodiment of the present invention is explained below with reference to the accompanying drawings. In the explanation of the embodiment, it is assumed that an image forming apparatus is a multifunction color copying apparatus (an MFP).

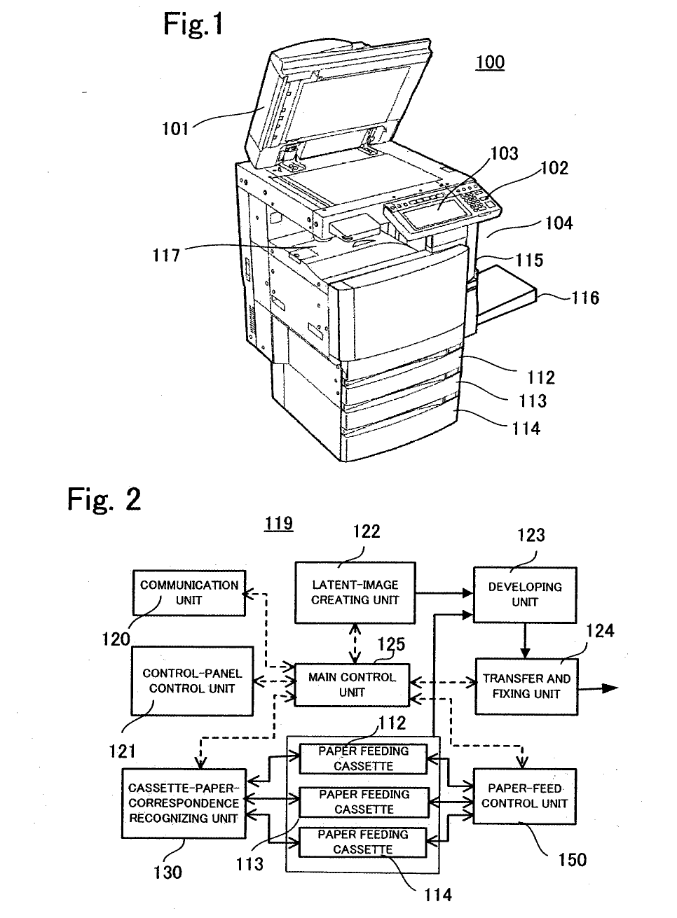

FIG. 1 is a perspective view showing an example of an appearance of the multifunction copying apparatus according to the embodiment of the present invention.

An auto document feeder (ADF) 101 that also serves as an original cover and automatically feeds sheet-like originals one by one is openably and closably provided in an upper part of an apparatus main body 100. An operation panel 102 including various operation keys and various display devices for instructing copy conditions and copy start is provided in a front section of an upper surface of the apparatus main body 100. A touch panel display 103 on which various kinds of information are displayed for a user and with which, when the user is requested to input information, the user can perform predetermined input by touching the same is provided beside the operation panel 102.

A handle 104 is provided on a right side of the apparatus main body 100 to allow the user to open the inside of the main body when paper jam or the like occurs.

Paper feeding cassettes 112, 113, and 114 are detachably provided in a lower part of the apparatus main body 100. In the respective paper feeding cassettes, paper for color printing and paper for monochrome of different paper types are stored. In printing, the paper is selected and fed as described below.

An automatic duplex unit 115 for performing duplex copying and a manual paper feeding device are openably and closably provided in a right side section of the apparatus main body 100. A tray 116 of the manual paper feeding device is a paper feeding device that can be folded when not in use and is used to feed paper not present in the paper feeding cassettes. A paper discharge tray 117 that receives printed paper is provided on the opposite side of the apparatus main body 100.

A schematic electric configuration of the MFP according to this embodiment is shown in FIG. 2.

An MFP 119 includes a communication unit 120 connected to the outside by a network, a control-panel control unit 121 that controls an entire control panel including the operation panel 102 and the touch panel display 103 shown in FIG. 1, a latent-image creating unit 122 that scans an original when copying or the like is performed in the apparatus and creates, for example, an electrostatic latent image, a developing unit 123 that develops the latent image created by the latent-image creating unit, a transfer and fixing unit 124 that, for example, transfers the developed image onto predetermined paper and fixes the image thereon, the plural paper feeding cassettes 112, 113, and 114, a cassette-paper-correspondence recognizing unit 130 that checks whether paper stored in the paper feeding cassettes is paper for color printing or paper for monochrome printing and recognizes a correspondence relation between the paper feeding cassettes and the paper as described later, a paper-feeding control unit 150 that specifies one of the paper feeding cassettes according to an image to be developed and controls feeding of the paper stored in the specified paper feeding cassette as described later, and a main control unit 125 that adjusts and controls the units as a whole.

In this embodiment, the multifunction copying apparatus has two modes. One mode is a mode (a correspondence relation storage mode) for creating and storing, when paper is stored in any one of the paper feeding cassettes 112, 113, and 114 and the paper feeding cassette is inserted and set in the apparatus main body 100, a cassette-paper correspondence table for distinguishing whether the paper stored in the set paper feeding cassette is paper for color printing or paper for monochrome printing. The other mode is a mode (a printing mode) for specifying, when, for example, the user prints an image, a paper feeding cassette in which paper suitable for color printing is stored according to the cassette-paper correspondence table if it is appropriate to print the image in color and printing the image on paper fed from the specified paper feeding cassette.

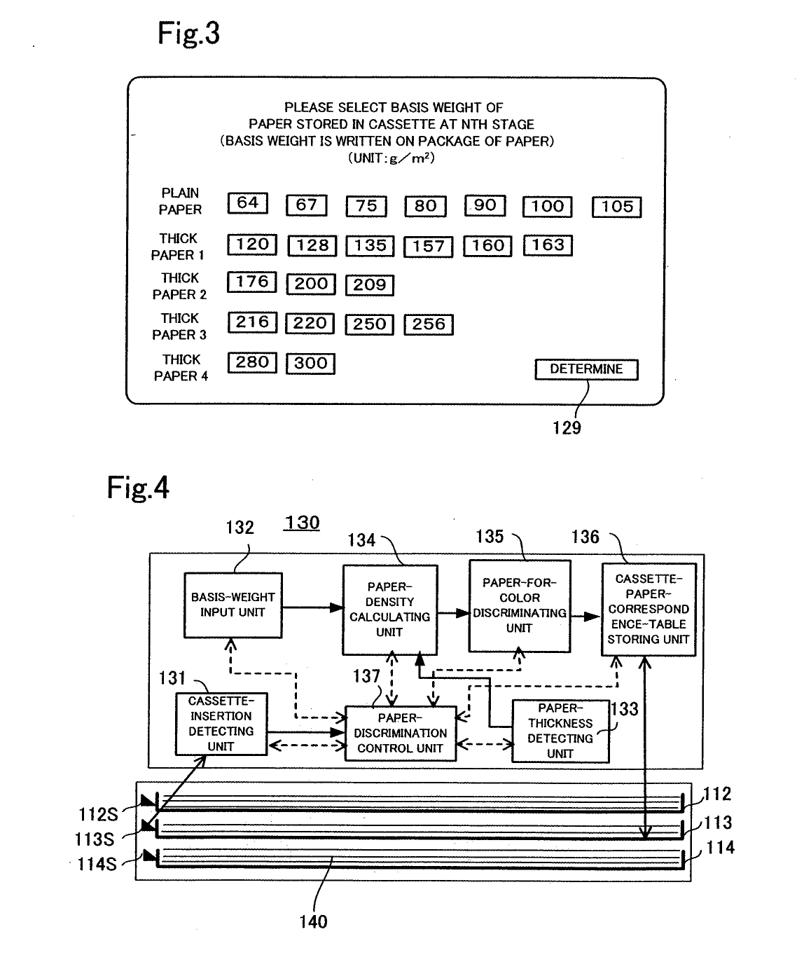

FIG. 3 is a diagram showing an example of a display screen that is displayed on the touch panel display 103 when the paper feeding cassettes are set in the apparatus main body and urges the user to input basis weight.

FIG. 4 is a diagram showing a configuration example of the cassette-paper-correspondence recognizing unit 130. The cassette-paper-correspondence recognizing unit 130 includes a cassette-insertion detecting unit 131 that detects insertion of the paper feeding cassettes 112, 113, and 114, a basis-weight input unit 132 including the touch panel display 103 to which basis weight is inputted by the user, a paper-thickness detecting unit 133 that detects paper thickness of the paper stored in the paper feeding cassettes, a paper-density calculating unit 134 that calculates the density of the paper from the paper thickness detected by the paper-thickness detecting unit 133 and the inputted basis weight, a paper-for-color discriminating unit 135 that discriminates whether the paper if paper for color printing according to the calculated density of the paper is equal to or larger than a predetermined value, for example, 0.8 g/cm³, a cassette-paper-correspondence-table storing unit 136 that stores, as a table, information on whether paper for color printing is stored or paper for monochrome printing is stored in the paper feeding cassettes, and a paper-discrimination control unit 137 that controls the units.

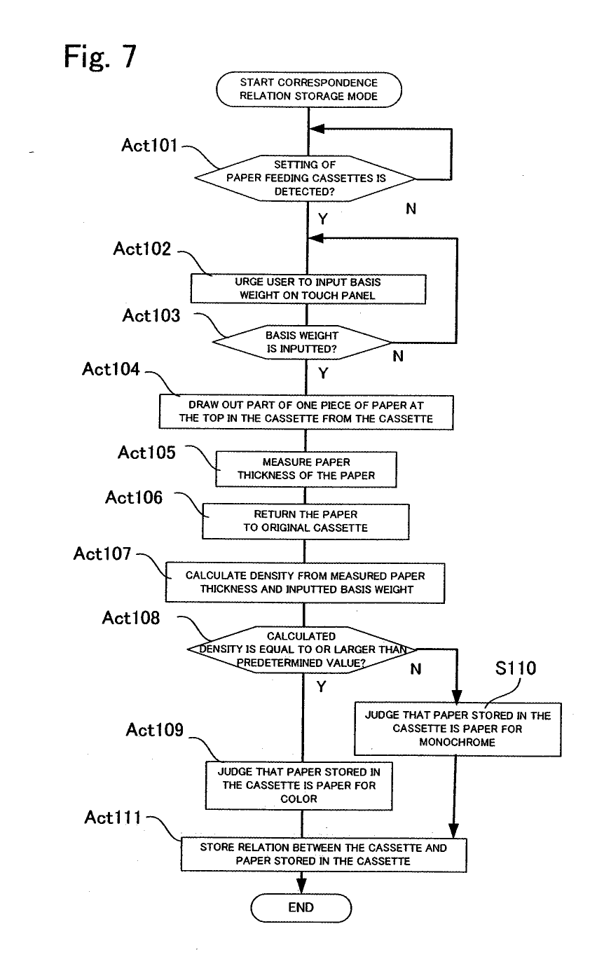

The paper-feeding control unit 150 includes, as shown in FIG. 6, a print-image detecting unit 152 that detects an image instructed to be printed, a print-image discriminating unit 153 that discriminates whether the image detected by the print-image detecting unit 152 is an image of a color original or an image of a monochrome original, a print-paper determining unit 154 that determines print paper using a result of the discrimination in the print-image discriminating unit 153 and with reference to the cassette-paper correspondence table stored in the cassette-paper-correspondence-table storing unit 136, and a cassette selecting unit 155 that specifies any one of the paper feeding cassettes 112, 113, and 114, on paper fed from which the image instructed to be printed is printed, on the basis of a result of the determination of the print paper.

Operations in the mode (the correspondence relation storage mode) for creating and storing the cassette-paper correspondence table in the MFP are explained with reference to a flowchart shown in FIG. 7. First, in Act 101, the cassette-insertion detecting unit 131 detects whether the paper feeding cassettes are inserted.

Cassette insertion detection switches 112S, 113S, and 114S that are turned on when depressed are provided at rear ends of the paper feeding cassettes 112, 113, and 114. Therefore, when paper is stored in any one of the paper feeding cassettes, for example, the paper feeding cassette 113 and the cassette is inserted in the apparatus main body 100, the cassette insertion detection switch 113S corresponding to the paper feeding cassette 113 is turned on and the cassette-insertion detecting unit 113 is notified of the insertion.

In the next Act 102, the paper-discrimination control unit 137 receives a cassette insertion signal from the cassette-insertion detecting unit 131, transmits a control signal to the basis-weight input unit 132, and urges the user to input basis weight.

An example of a screen for urging the user to input basis weight is shown in FIG. 3. When the user inserts, for example, the paper feeding cassette 113 in the apparatus main body, the screen shown in FIG. 3 is displayed on the touch panel display 103 (Act 103). An indication “please select basis weight of paper stored in a paper feeding cassette at an Nth stage” is displayed on the screen. Under the indication, an indication “(basis weight is written on a package of paper) (unit: g/m²)” is displayed.

Concerning plain paper, seven values, 64, 67, 75, 80, 90, 100, and 105, are displayed as icons of basis weight. Concerning thick paper 1, six values, 120, 128, 135, 157, 160, and 163, are displayed as icons of basis weight.

Concerning thick paper 2, three values, 176, 200, and 209, are displayed as icons of basis weight. Concerning thick paper 3, four values, 216, 220, 250, and 256 are displayed as icons of basis weight. Concerning thick paper 4, two values, 280 and 300, are displayed as icons of basis weight. The user touches any one of these twenty-two icons with a finger and, then, touches a determination icon 129. When basis weight is inputted in this way, the inputted basis weight is transmitted to the paper-density calculating unit 134.

When paper having basis weight not shown on the screen is used, a basis weight icon closest to the basis weight may be selected or a numerical value may be inputted by using a ten key provided in the operation panel 102.

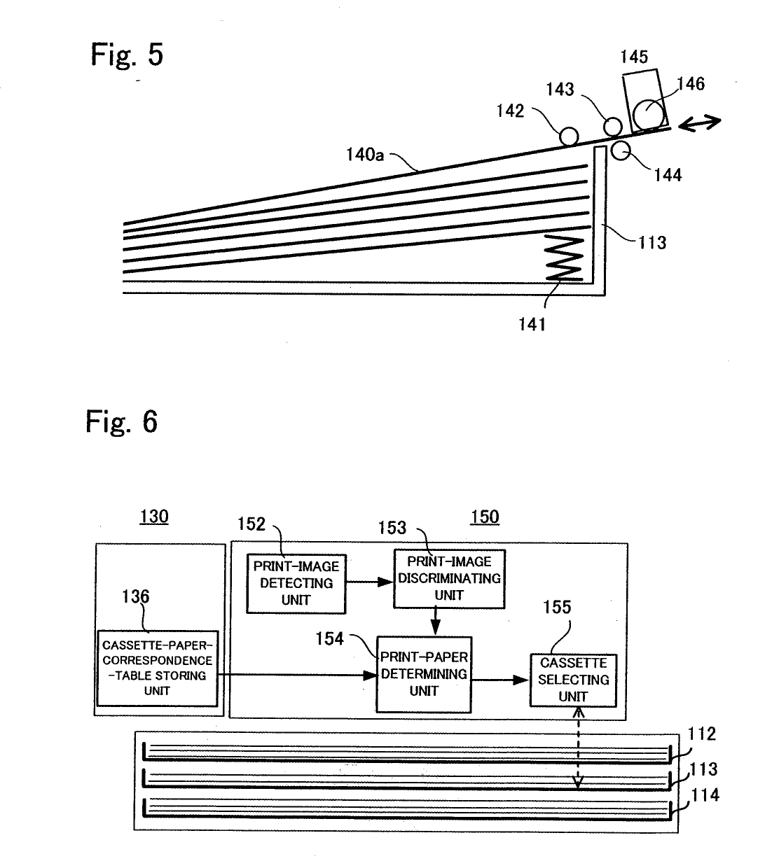

From the next act, the paper-thickness detecting unit 133 detects the thickness of paper 140 stored in the paper feeding cassette 113. A process of the detection is explained with reference to FIG. 5. The paper 140 is stored in the paper feeding cassette 113 as a paper bundle. The paper 140 is pushed upward from a rear surface thereof by a pressing spring 141. First, at Act 104, a part of one piece of paper 140a at the top of the paper bundle is drawn out from the paper feeding cassette 113 by rotating a pickup roller 142, a paper feeding roller 143, and a separation roller 144. The thickness of the paper 140a at the top drawn out by these rollers is measured by a paper thickness sensor 145 (Act 105). The paper thickness sensor 145 calculates paper thickness from a vertical displacement amount.

Thereafter, at Act 106, the paper 140a at the top is returned to the paper feeding cassette 113 by reversely rotating the pickup roller 142, the paper feeding roller 143, and the separation roller 114 (Act 106). The paper-density calculating unit 134 calculates the density of the paper from the thickness of the paper 140a measured at Act 105 and the basis weight inputted by the user in Act 103.

Between the basis weight and the density of the paper, there is a relation of basis weight=paper thickness×density. Therefore, the basis weight inputted by the user is divided by the paper thickness detected by the paper-thickness detecting unit 133. A division value is transmitted to the paper-for-color discriminating unit 135.

In general, the density of recommended paper for color printing is equal to or larger than 0.8 g/cm³. Therefore, the paper-for-color discriminating unit 135 discriminates, using a comparator, whether the density of the paper calculated by the paper-density calculating unit 134 is equal to or larger than a predetermined value, for example, 0.8 g/cm³ (Act 108). When it is judged in Act 108 that the calculated density is equal to or larger than 0.8 g/cm³, in Act 109, the paper-for-color discriminating unit 135 judges that the paper stored in the paper feeding cassette 113 is paper for color printing.

On the other hand, when it is judged that the density calculated by the paper-density calculating unit 134 is smaller than 0.8 g/cm³, the paper-for-color discriminating unit 135 judges that the paper stored in the paper feeding cassette is not the paper for color printing but is paper for monochrome printing (Act 110).

In the next Act 111, the cassette-paper-correspondence-table storing unit 136 creates and stores a correspondence relation of the paper for color printing with respect to the paper feeding cassette 113 as a cassette-paper correspondence table.

In this way, it is judged whether the paper for color printing or the paper for monochrome printing is stored in the respective paper feeding cassettes and the cassette-paper correspondence table is created and stored.

The mode for storing a corresponding relation between the paper feeding cassettes and the paper stored therein is finished.

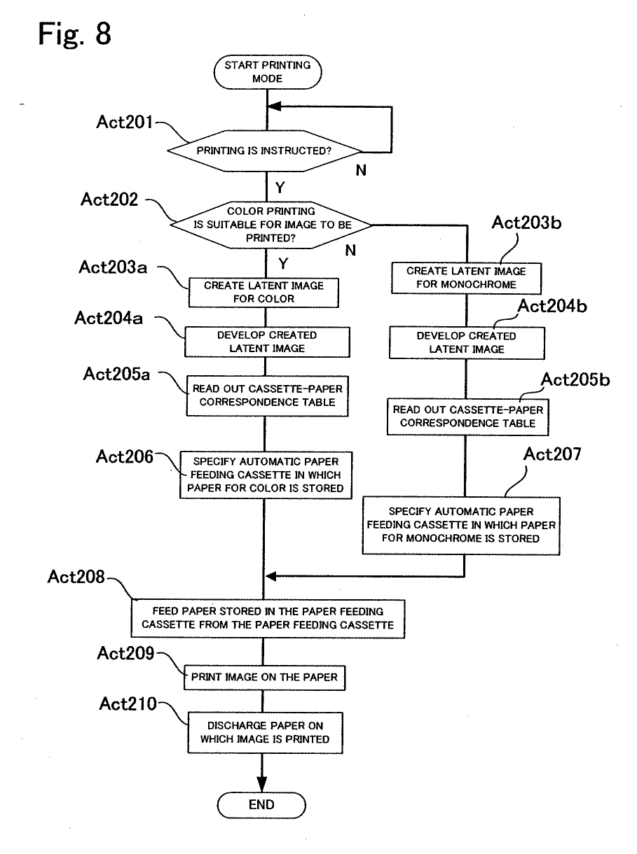

The mode for printing an image is explained with reference to a flowchart shown in FIG. 8. As an example, copying of a certain book by the multifunction color copying apparatus according to the embodiment is explained.

In Act 201, it is monitored whether the user instructs printing by pressing a button of the operation panel 102. When printing is instructed, in Act 202, it is judged whether color printing is appropriate for an image to be printed, specifically, whether the book is a color original or a monochrome original. When an original image to be copied is a color image, usually, it is judged that the color printing is appropriate. When an image is transmitted from the outside, it is judged whether the image is a color image by checking an image signal. It is automatically judged whether the color printing is appropriate for the image to be copied or the image transmitted from the outside.

However, even if the image is a color image, the user may desire monochrome printing. Therefore, it is also possible to provide a desire selection button in the operation panel 102 to urge the user to select whether the image should be printed as a color image.

When it is judged that the color printing is appropriate, the processing shifts to Act 203a and a latent image for color is created. On the other hand, when it is judged in Act 202 that color printing is not appropriate, the processing shifts to Act 203b and a latent image for monochrome is created. In both the cases, the latent-image creating unit 122 shown in FIG. 2 scans, for example, the image to be copied, projects an optical image of the image on a photoconductive drum, and creates an electrostatic latent image.

In the next Acts 204a and 204b, the developing unit 123 develops, with, for example, toner powder, the electrostatic latent image for color or the electrostatic image for monochrome created by the latent-image creating unit 122. The cassette-paper correspondence table stored in the cassette-paper-correspondence-table storing unit 136 of the cassette-paper-correspondence recognizing unit 130 is read out in the next Acts 205a and 205b.

When it is judged in Act 202 that the color printing is appropriate, the processing shifts from Act 205a to Act 206 and a paper feeding cassette in which the paper for color printing is stored is specified. For example, when it is judged that the color printing is appropriate for the paper, the paper feeding cassette 113 is specified.

On the other hand, when the color printing does not have to be performed for the image to be printed, the processing shifts from Act 205b to Act 207. A paper feeding cassette in which the paper for monochrome is stored is specified. The specifying of the paper feeding cassette is a preliminary stage for feeding the paper from the paper feeding cassette.

In the next Act 208, one piece of the paper stored in the specified paper feeding cassette is fed from the cassette. In the next Act 209, the image developed in Act 203 is printed on the fed paper. Specifically, this processing is performed in the transfer and fixing unit 124 shown in FIG. 2. In Act 210, the paper on which the image is printed is discharged from the paper discharge tray 117.

In this way, in the printing mode, the image is printed on the paper for color printing or the paper for monochrome printing.

In the embodiment, when a paper feeding cassette is inserted, the multifunction color copying apparatus causes the user to input basis weight of paper stored in the cassette and judge whether the paper is paper suitable for color printing. However, the multifunction color copying apparatus may cause the user to judge, prior to printing of an image, whether paper stored in a specific paper feeding cassette is paper suitable for color printing. The multifunction color copying apparatus may cause the user to judge, when the manual feed tray 116 is inserted instead of the paper feeding cassette, whether paper stored in the tray is paper suitable for color printing. In this case, the multifunction color copying apparatus can also cause the user to judge, prior to printing of an image, propriety of color printing of the paper stored in the tray.

In the embodiment, a part of the paper at the top is drawn out from the paper feeding cassette and the paper thickness thereof is measured. However, measurement of paper thickness can be performed by other methods, for example, can be performed optically. For example, a light source that irradiates light on an upper surface of paper at the top of a paper bundle and a light receiving device that receives light leaking from a side of the paper bundle are provided in the paper feeding cassette. If this combination of the light source and the light receiving device is provided in the paper feeding cassette to measure paper thickness, there is an advantage that it is unnecessary to temporarily draw out the paper from the cassette in order to measure paper thickness.

In the explanation of the embodiments, the present invention is applied to the multifunction color copying apparatus. However, the present invention can be applied not only to the multifunction color copying apparatus but also to other image forming apparatuses such as a normal copying machine, a printer, and a facsimile that have image creating units, which create images to be printed on recording paper, and designate types of paper on which the images are printed.

Obviously, many modifications and variations of this invention are possible in light of the above teachings. It is therefore to be understood that within the scope of the appended claims, this invention may be practiced otherwise than as specification described.

What is claimed is:

1. An image forming apparatus comprising:
an apparatus main body;
an operation panel that is provided in the apparatus main body and used for instructing printing of a formed image;
plural paper feeding cassettes that store paper for color printing or paper for monochrome printing on which the image is printed; and
a cassette-paper-correspondence recognizing unit that is provided in the apparatus main body and recognizes whether the paper stored in the plural paper feeding cassettes is the paper for color printing or the paper for monochrome printing.

2. The apparatus according to claim 1, wherein the cassette-paper-correspondence recognizing unit includes:
a basis-weight input unit to which basis weight of the paper stored in the plural paper feeding cassette is inputted;
a paper-thickness detecting unit that measures paper thickness of the paper stored in the paper feeding cassettes;
a paper-density calculating unit that calculates, from the paper thickness measured by the paper-thickness detecting unit and the basis weight inputted to the basis-weight input unit, density of paper stored in a specific paper feeding cassette;
a density comparing unit that compares the density calculated by the paper-density calculating unit with a predetermined value; and
a correspondence-relation storing unit that stores a cassette-paper correspondence relation as a table by associating the specific paper feeding cassette with the paper for color printing when the density comparing unit judges that the density of the paper is equal to or larger than the predetermined value and associating the specific paper feeding cassette with the paper for monochrome printing when the density comparing unit judges that the density of the paper is smaller than the predetermined value.

3. The apparatus according to claim 2, wherein the paper-density calculating unit calculates density of the paper by dividing the basis weight inputted to the basis-weight input unit by the paper thickness measured by the paper-thickness detecting unit.

4. The apparatus according to claim 3, wherein the basis weight is inputted to the basis-weight input unit from the operation panel.

5. The apparatus according to claim 4, wherein
the operation panel includes a touch panel display, and
a user inputs the basis weight to the basis-weight input unit by touching any one of plural values of basis weight displayed on the touch panel display.

6. The apparatus according to claim 4, wherein
the operation panel includes a ten key, and
a user inputs the basis weight to the basis-weight input unit by inputting a numerical value of the basis weight using the ten key.

7. The apparatus according to claim 2, wherein the paper-thickness detecting unit draws out a part of paper at the top stored in the plural paper feeding cassettes and measures paper thickness of the paper.

8. The apparatus according to claim 2, wherein the paper-thickness detecting unit detects paper thickness of the paper by irradiating light on an upper surface or a lower surface of plural pieces of paper stored in the plural paper feeding cassettes and measuring light leaking from a side of the plural pieces of paper.

9. An image forming apparatus comprising:
an apparatus main body;
an operation panel that is provided in the apparatus main body and used for instructing printing of an image;
plural paper feeding cassettes that store paper for color printing or paper for monochrome printing on which the image is printed;
a cassette-paper-correspondence recognizing unit that is provided in the apparatus main body and recognizes a cassette-paper correspondence relation indicating whether the paper stored in the plural paper feeding cassettes is the paper for color printing or the paper for monochrome printing;
a paper-feed control unit that specifies, when the image instructed to be printed is an image suitable for color printing, a paper feeding cassette in which the paper for color printing is stored with reference to a cassette-paper correspondence table stored by the cassette-paper-correspondence recognizing unit; and
a printing unit that feeds the paper stored in the paper feeding cassette specified by the paper-feed control unit and prints the image.

10. The apparatus according to claim 9, wherein
the paper-feed control unit includes:
a print-image discriminating unit that discriminates whether the image instructed to be printed is an image of a color original or an image of a monochrome original; and
a cassette selecting unit that specifies, on the basis of a result of the discrimination by the print-image discriminating unit, the paper feeding cassette, on the paper fed from which the image instructed to be printed is printed, with reference to the cassette-paper correspondence table.

11. The apparatus according to claim 9, wherein the cassette-paper-correspondence recognizing unit includes:
a basis-weight input unit to which basis weight of the paper stored in the plural paper feeding cassettes is inputted;
a paper-thickness detecting unit that measures paper thickness of the paper stored in the paper feeding cassettes;
a paper-density calculating unit that calculates, from the paper thickness measured by the paper-thickness detecting unit and the basis weight inputted to the basis-weight input unit, density of paper stored in a specific paper feeding cassette;
a density comparing unit that compares the density calculated by the paper-density calculating unit with a predetermined value; and
a correspondence-relation storing unit that stores a cassette-paper correspondence relation as a table by associating the specific paper feeding cassette with the paper for color printing when the density comparing unit judges that the density of the paper is equal to or larger than the predetermined value and associating the specific paper feeding cassette with the paper for monochrome printing when the density comparing unit judges that the density of the paper is smaller than the predetermined value.

12. The apparatus according to claim 11, wherein the paper-density calculating unit calculates density of the paper by dividing the basis weight inputted to the basis-weight input unit by the paper thickness measured by the paper-thickness detecting unit.

13. The apparatus according to claim 11, wherein the predetermined value is 0.8 g/cm³.

14. A printing method for an image forming apparatus for feeding, when printing of a created image is instructed by a user from an operation panel provided in an apparatus main body, paper from any one of plural paper feeding cassettes and printing the image, the printing method comprising:
discriminating whether the image instructed to be printed is an image of a color original or an image of a monochrome original;
specifying, when it is discriminated that the image is an image of a color original, a paper feeding cassette in which paper suitable for printing of the image of the color original is stored with reference to a cassette-paper correspondence table indicating whether the paper stored in the plural paper feeding cassettes is the paper for color printing or the paper for monochrome printing; and
feeding the paper stored in the paper feeding cassette and printing the image instructed to be printed.

15. A printing method for an image forming apparatus comprising:
receiving basis weight of paper stored in plural paper feeding cassette;
measuring paper thickness of the paper stored in the paper feeding cassettes;
calculating, from the measured paper thickness and the received basis weight, density of paper stored in a specific paper feeding cassette;
comparing the calculated density with a predetermined value;
storing a cassette-paper correspondence relation as a table by associating the specific paper feeding cassette with the paper for color printing when it is judged that the density of the paper is equal to or larger than the predetermined value and associating the specific paper feeding cassette with the paper for monochrome printing when it is judged that the density of the paper is smaller than the predetermined value;
specifying, when printing of an image of a color original is instructed, a paper feeding cassette in which the paper for color printing is stored with reference to the cassette-paper correspondence table; and
feeding the paper stored in the paper feeding cassette and printing the image instructed to be printed.

16. The method according to claim 15, wherein the density is calculated by dividing the received basis weight by the measured paper thickness.

17. The method according to claim 15, wherein the predetermined value is 0.8 g/cm³.

18. The apparatus according to claim 2, wherein the predetermined value is 0.8 g/cm³.
